(19) United States
(12) Patent Application Publication
(10) Pub. No.: US 2026/0284862 A1
(43) Pub. Date: Sep. 24, 2026

(54) ROBOTIC SIMULATION SYSTEM WITH HUMAN-LIKE SILICONE SKIN

(71) Applicant: Matthew Shun, Glendale, CA (US)

(72) Inventor: Matthew Shun, Glendale, CA (US)

(21) Appl. No.: 19/244,176

(22) Filed: Jun. 20, 2025

Related U.S. Application Data
(60) Provisional application No. 63/774,850, filed on Mar. 20, 2025.

(51) Int. Cl. B25J 9/00; B25J 9/16

(52) U.S. Cl. CPC B25J 9/0006; B25J 9/0012; B25J 9/1671

(57) ABSTRACT

A robotic simulation system that enables a robot to appear and behave more human-like while maintaining modularity, serviceability, and sensory responsiveness is disclosed. The system includes molded silicone body modules shaped to resemble human anatomical features, such as a face or limb, and configured for thermal and tactile realism. These modules are coupled to a robot's internal metallic structure using a plug-and-socket assembly. The plug comprises a silicone outer sleeve, a neoprene inner sleeve, magnetized pellets, and electromagnetic coil-wrapped washers to enable magnetic locking. The socket includes corresponding sleeves, pellet cavities, and induction elements to receive and secure the plug. The system also incorporates thin metal strips that function as nerve sensors and complete an electrical circuit upon attachment, confirming successful installation. The invention enables robots to simulate human skin temperature, expression, and touch, enhancing their utility in social, medical, and service applications.

### CROSS-REFERENCE TO RELATED APPLICATION

The present application claims priority to, and the benefit of, U.S. Provisional Application No. 63/774,850 which was filed on Mar. 20, 2025 and is incorporated herein by reference in its entirety.

### FIELD OF THE INVENTION

The present invention generally relates to humanoid robotics. More specifically, the present invention relates to a robotic simulation system configured to enhance the physical realism, modularity, and tactile responsiveness of humanoid robots. The invention comprises a system of molded silicone skin modules shaped to resemble (i.e., simulate) human anatomical features and equipped with embedded components for thermal regulation, sensory feedback, and secure magnetic attachment. Each module includes a plug-and-socket mechanism featuring magnetized pellets, electromagnetic coil assemblies, and soft compression sleeves, enabling reliable and detachable integration with a robot's internal metallic framework. Additionally, the system incorporates thin rubber tubing for circulating warm fluid to simulate skin temperature, and thin metal strips functioning as nerve sensors to detect touch and adjust applied force. Accordingly, this present disclosure makes specific reference thereto. Nonetheless, it is to be appreciated that aspects of the present invention are also equally applicable to other like applications, devices, and methods of manufacture.

### BACKGROUND

By way of background, human-like robots are increasingly being utilized in a variety of applications, including research, education, medical training, customer interaction, and therapeutic environments. Such humanoid robots are often designed to replicate the form and behavior of humans to facilitate more natural and effective human-robot interaction. However, despite advancements in mechanical articulation and artificial intelligence, conventional robots still fall short in replicating the full human experience.

Furthermore, standard robotic designs often exhibit hard, cold, and metallic surfaces that are visually and physically uninviting. While some robots may possess human-like shapes or facial features, they lack essential elements such as realistic skin texture, natural warmth, and lifelike muscle movement. As a result of lack of essential human elements, standard robots lack emotional engagement, reduce user comfort, and limit the utility of robots in socially sensitive or tactilely interactive environments. Individuals desire a system that not only improves the appearance of robots to more closely resemble human beings but also enhances tactile comfort and their functionality.

Therefore, there exists a long-felt need in the field of robotics for a modular system that enhances the physical realism of humanoid robots. There is a long-felt need for robotic systems that not only mimic human form but also replicate tactile characteristics such as warmth, soft skin texture, and pressure sensitivity. Furthermore, there is a need for robotic external components that can be securely attached and easily replaced without compromising form or function. More specifically, there is a long-felt need for a realistic, sensor-integrated, temperature-regulated synthetic skin system that is both user-friendly and compatible (i.e., attachable) with modular robotic platforms. Also, there is a long-felt need in the art for a system that enables robotics to be equipped with the moulded silicone components to fully resemble a human. Finally, there is a long-felt need in the art for a system that offers a way to improve robotic functionality for education, research, and more.

The subject matter disclosed and claimed herein, in one embodiment, comprises a robotic simulation system designed to enable robots to appear and feel more human-like while remaining modular, serviceable, and responsive. The system includes externally mounted, molded silicone modules shaped to resemble various human body parts such as the face, arms, and legs. Each module comprises a silicone outer body layer. These synthetic layers attach to the underlying robotic frame using a plug-and-socket mechanism that provides mechanical stability, magnetic locking, and electronic feedback. The plug assembly includes magnetized pellets, iron washers, and copper coils that generate a secure magnetic bond when activated. The corresponding socket includes compatible (i.e., attachable) materials and coil assemblies to receive and lock the plug in place. The system is embedded with rubber tubing for circulating warm fluid, and thin metal strips acting as nerve sensors to detect touch and pressure.

In another embodiment, the robotic simulation system includes a set of thin copper or nickel metal strips integrated into both the plug and the socket, designed to complete an electrical circuit upon successful attachment. This closed-loop signal is sent to the robot's processing unit to confirm secure installation of the skin module.

In this manner, the robotic simulation system of the present invention fulfills the long-felt need for a lifelike, responsive, and modular human-simulation interface for robots. The system improves both aesthetic and functional realism, enabling robots to participate more naturally in social, therapeutic, and customer-facing roles. It provides an effective solution for researchers, educators, healthcare providers, and developers seeking realistic interaction models. Using the system, the robots better resemble humans and are much more comfortable to the touch.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a robotic simulation system for providing a humanoid appearance and tactile response to a robot. The system comprises a molded silicone body module shaped to resemble a human anatomical feature, the silicone body module including a silicone outer body layer and human anatomical features, a robot internal metallic member, the member includes a plurality of actuators configured to simulate facial or limb expressions, a plurality of force sensors configured to detect pressure or touch, at least one thin rubber tube configured to transport temperature-controlled water to regulate surface temperature, and at least one thin metal strip positioned adjacent to the thin rubber tube and configured to function as a nerve sensor to detect contact and adjust force. A plug and socket assembly is configured to mechanically and magnetically couple the molded silicone body module to the robot internal metallic member.

The plug comprises a silicone outer sleeve, a neoprene inner sleeve, a cavity containing magnetized pellets, a tongue extension for alignment, and one or more induction coils with iron washers for magnetic engagement. The socket comprises a socket cavity with corresponding magnetized pellets, a silicone inner sleeve, a neoprene outer sleeve, and one or more induction coil washers for magnetic locking.

In another embodiment, a method of securing a robotic skin module to a robot body using a plug and socket mechanism is described. The method comprises the steps of inserting a plug having a tongue extension into a socket cavity lined with a soft sleeve, compressing the silicone and neoprene sleeves of the plug and socket to form a tight mechanical seal, aligning and engaging magnetized pellets contained in the plug and socket for 360-degree magnetic grip, enabling electrical metal strips in the plug and socket to contact and complete an electrical circuit, activating one or more induction coils surrounding iron washers to generate a magnetic field that locks the plug to the socket, and transmitting a signal from the completed circuit to the robot's processing unit confirming successful attachment.

In one embodiment, a modular plug for robotic skin attachment is disclosed. The modular plug includes a silicone outer sleeve configured to simulate human skin texture, a neoprene inner sleeve providing compressive support and flexibility, a cavity within the neoprene inner sleeve containing a plurality of magnetized pellets, an iron washer disposed at a top and a base of the plug, a wire coil surrounding each iron washer and configured to generate an electromagnetic field when energized, a tongue extension protruding from the plug for interlocking with a corresponding socket, and at least one thin metal strip positioned on the plug and configured to complete an electrical circuit when connected with a corresponding strip in the socket to confirm attachment.

In yet another aspect, the socket module for use in a robotic simulation system includes an outer neoprene sleeve configured for vibration dampening and mechanical insulation, an inner silicone sleeve providing thermal and electrical insulation and a soft gripping interface, a socket cavity configured to receive a plug and housing a plurality of magnetized pellets aligned for multi-point engagement with plug pellets, at least one coil-integrated washer disposed at a top and base of the socket and configured to generate a magnetic field when current is applied, and an endplate coil disposed at the base of the socket to provide additional magnetic or mechanical locking.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the robotic simulation system of the present invention in accordance with the disclosed structure;

FIG. 2 illustrates an enlarged view of another embodiment of the robotic simulation system in the form of a robot arm in accordance with the disclosed structure;

FIG. 3 illustrates a plug module used in the robotic simulation system of the present invention in accordance with the disclosed structure;

FIG. 4 illustrates a perspective view showing the socket module used in the robotic simulation system of the present invention in accordance with the disclosed structure;

FIG. 5 illustrates a flow chart depicting a process of securing the plug and the socket module in accordance with the disclosed structure; and

FIG. 6 illustrates a standalone view of the electrical metal strips used in the robotic simulation system of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the field of robotics for a modular system that enhances the physical realism of humanoid robots. There is a long-felt need for robotic systems that not only mimic human form but also replicate tactile characteristics such as warmth, soft skin texture, and pressure sensitivity. Furthermore, there is a need for robotic external components that can be securely attached and easily replaced without compromising form or function. More specifically, there is a long-felt need for a realistic, sensor-integrated, temperature-regulated synthetic skin system that is both user-friendly and compatible (i.e., attachable) with modular robotic platforms. Also, there is a long-felt need in the art for a system that enables robotics to be equipped with the moulded silicone components to fully resemble a human. Finally, there is a long-felt need in the art for a system that offers a way to improve robotic functionality for education, research, and more.

The present invention, in one exemplary embodiment, is a method of securing a robotic skin module to a robot body using a plug and socket mechanism. The method comprises the steps of inserting a plug having a tongue extension into a socket cavity lined with a soft sleeve, compressing the silicone and neoprene sleeves of the plug and socket to form a tight mechanical seal, aligning and engaging magnetized pellets contained in the plug and socket for 360-degree magnetic grip, enabling electrical metal strips in the plug and socket to contact and complete an electrical circuit, activating one or more induction coils surrounding iron washers to generate a magnetic field that locks the plug to the socket, and transmitting a signal from the completed circuit to the robot's processing unit confirming successful attachment.

Reference will now be made in detail to the present preferred embodiments of the invention, examples of which are illustrated in the accompanying drawings. Wherever possible, the same reference numerals are used in the drawings and the description to refer to the same or like parts.

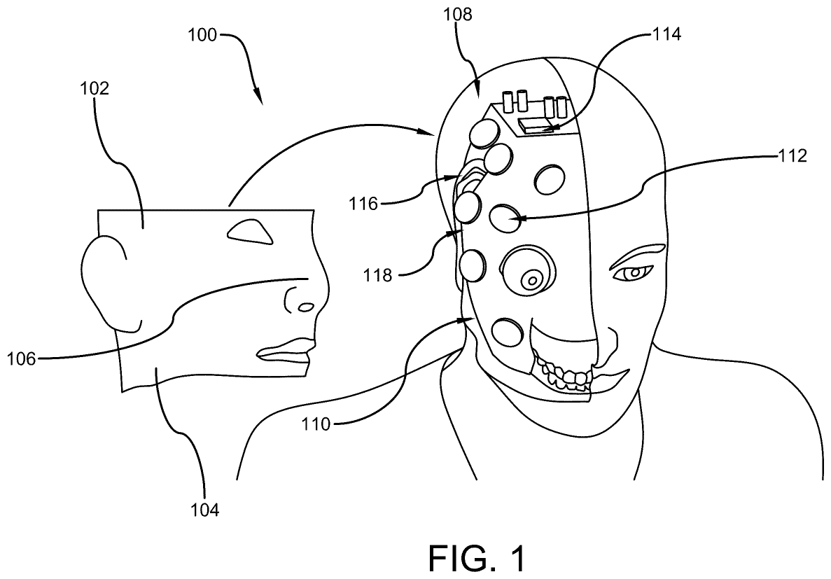

Referring initially to the drawings, FIG. 1 illustrates a perspective view of one potential embodiment of the robotic simulation system of the present invention in accordance with the disclosed structure. The robotic simulation system 100 of the present invention is designed to enable a robot to appear and feel human-like, while remaining serviceable, responsive, and modular. The system 100 includes various molded medical-grade silicone shaped in the form of simulated human body parts (arms, face, legs, etc.). As illustrated, the system 100 in the present embodiment is in the form of a humanoid robotic face skin module 102. The humanoid robotic face skin module 102 is constructed of molded medical-grade silicone shaped like a human face. The face 102 has a silicone outer body layer 104 and includes human anatomical features 106 such as mouth, nose, and a pair of eyes. A robot internal metallic member 108 is preferably metallic and mechanical and is compatible (i.e., attachable) to a robot's framework.

The robot internal metallic member 108 includes a plurality of actuators 110 for providing and simulating facial expressions of a human. A plurality of force sensors 112 enable a robot having the robotic face 102 to understand and react to pressure or touch. A plurality of connectors 114 connectible (i.e., attachable) to the metallic member inner layer 108 provide transmission of execution signals and control in movement of the robotic face 102. It should be noted that to completely simulate a human face, artificial teeth and jaw structures are included for accommodating speech and expressions.

The robot internal metallic member 108 includes a thin rubber tube 116 configured to transport temperature-controlled water throughout the robot's body and the water flow helps maintain a warm temperature, mimicking human skin temperature. At least one thin metal strip 118 functions as a nerve sensor and preferably runs parallel alongside the rubber tube 116. The metal strip 118 is configured to help the robot determine (i.e., measure) the amount of force or tactile pressure to use or apply when handling objects, improving tactile control. A plug and socket mechanism forms the interface between the robotic skin module 102, the internal metallic member 108, and the robot's framework as described later in the disclosure.

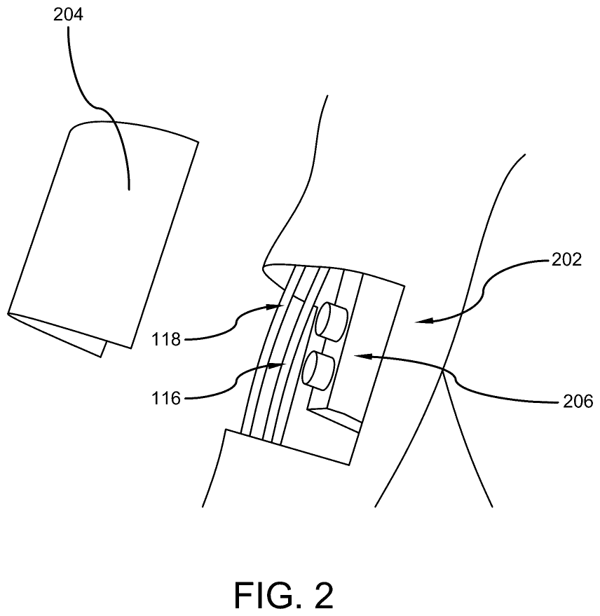

FIG. 2 illustrates an enlarged view of another embodiment of the robotic simulation system in the form of a robot arm in accordance with the disclosed structure. In the present embodiment, the robotic arm 202 includes the thin rubber tube 116 configured to transport temperature-controlled water throughout the robot's body and the water flow helps maintain a warm temperature, mimicking human skin temperature. Also, the thin metal strip 118 runs parallel to the rubber tube 116 for functioning as the nerve sensor. The arm silicone body 204 removably attaches to the robotic arm 202 for providing a human arm look and simulating functionality of a human arm. It should be noted that a plurality of force sensors 206 configured to simulate force of a user hand are disposed in the robotic arm 202.

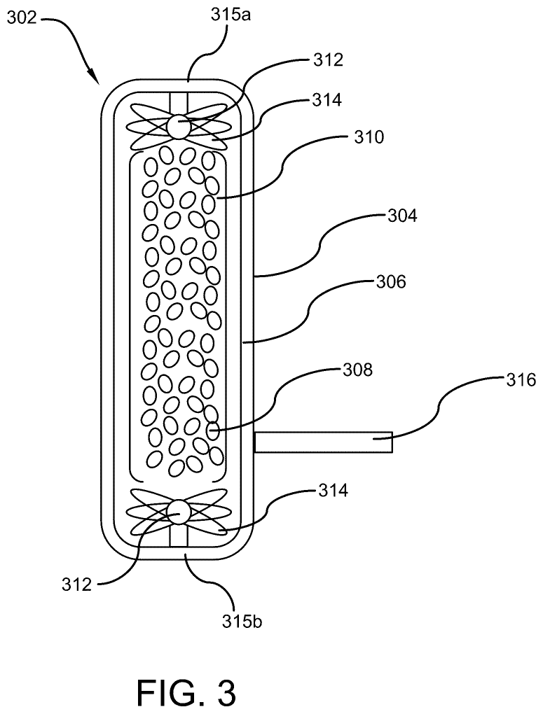

FIG. 3 illustrates a plug module used in the robotic simulation system of the present invention in accordance with the disclosed structure. The robotic simulation system 100 uses a plug and socket system that enables modular, lifelike robotic skins and body parts to be securely attached to a robot's mechanical frame. A plug 302 is integrated into the silicone body part inner layer and is configured to fit into a corresponding socket which is embedded in the robot's body. The plug 302 includes a silicone outer sleeve 304 made of soft and flexible silicone to provide a realistic human skin texture and to also protect internal components of the robotic skin module. The silicone outer sleeve 304 is adapted to mimic human epidermis.

A neoprene inner sleeve 306 is made of medium-density neoprene foam and provides softness and flexibility to enable compression during insertion of the skin module. A plurality of magnetized pellets 308 made preferably from ferromagnetic beads or stainless steel spheres are accommodated inside a cavity 310 formed by the neoprene inner sleeve 306. The magnetized pellets 308 are configured to provide multi-point magnetic engagement for strong, evenly distributed attachment of the robotic skin module with the robotic mechanical frame. An iron washer 312 made from ferritic stainless steel or iron serves as a core for electromagnetic field during activation of a wire coil 314 and increases magnetic flux and focusing during induction. The wire coil 314 is preferably made from copper and is oriented to wrap around the iron washer 312. A localized electromagnetic field is created when current passes through the coil 314 and helps in locking and unlocking of the silicone skin module. The iron washer 312 along with the wire coil 314 are disposed at the top end 315a and the bottom end 315b of the plug 302. In one exemplary embodiment, the plug 302 can be separated from the robotic simulation system 100 and used separately. The plug 302 when separated from the system 100 comprises a phallus shaped member (i.e., simulated penis) that can be stiffened and elongated by the magnetized pellets 308 inside the cavity 310. The plug 302, when separate, functions as a vibrator (i.e., personal massager) for independent use.

A tongue extension 316 is preferably rigid and is covered with silicone. The tongue extension 316 protrudes from the plug 302 to lock to the socket via interlocking or magnetic attraction. The tongue extension 316 helps with alignment of the plug 302 and a socket module 402.

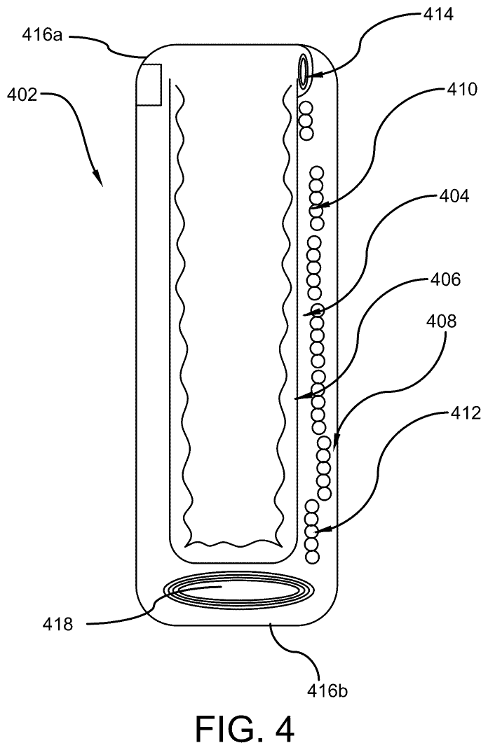

FIG. 4 illustrates a perspective view showing the socket module 402 used in the robotic simulation system of the present invention in accordance with the disclosed structure. The socket module 402 includes an outer neoprene sleeve 404 made from Neoprene rubber or similar elastomer and provides vibration dampening and insulation. The outer neoprene sleeve 404 also enhances mechanical shock absorption and comfort. An inner neoprene sleeve 406 is made from smooth and medical-grade silicone and provides a soft gripping layer for receiving plug 302. The inner neoprene sleeve 406 provides thermal and electrical insulation. In one exemplary usage of the socket 402 and the inner neoprene sleeve 406, when the plug 302 is removed, a human can insert an appendage (i.e., penis) into the socket 402 for self-gratification. In this manner, the socket 402 and the inner neoprene sleeve 406 simulates a female vagina.

A socket pellet casing 408 made from rigid polymer or metal has a continuous cavity 410 for storing a plurality of magnetized BBs 412 which are aligned with the set of magnetized pellets 308 of the plug 302. It should be noted that the magnetized pellets 308, 412 enable a strong 360 degrees magnetic grip for a secure attachment of the plug 302 and the socket 402.

A coil integrated washer 414 is disposed at the top 416a and base 416b of the socket 402. Further, the washer 414 works together with the coil of the plug 302 to induce magnetism and enables strong magnetic attraction force for secure attachment of the plug 302 and the socket 402. An endplate coil 418 is disposed at the base 416b of the socket to provide an additional locking mechanism, either magnetic or mechanical and prevents accidental release, especially for load-bearing modules (not shown).

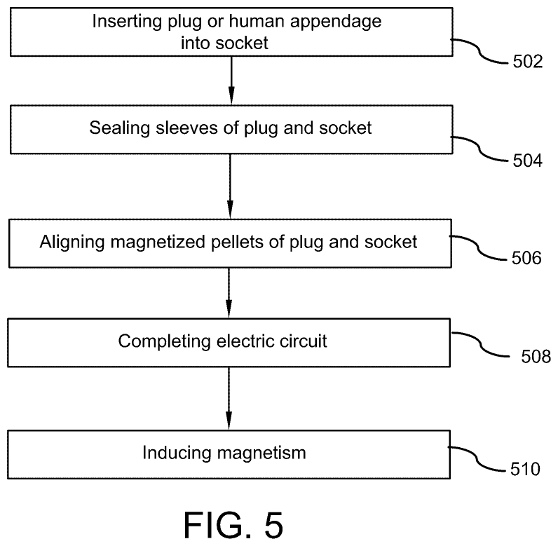

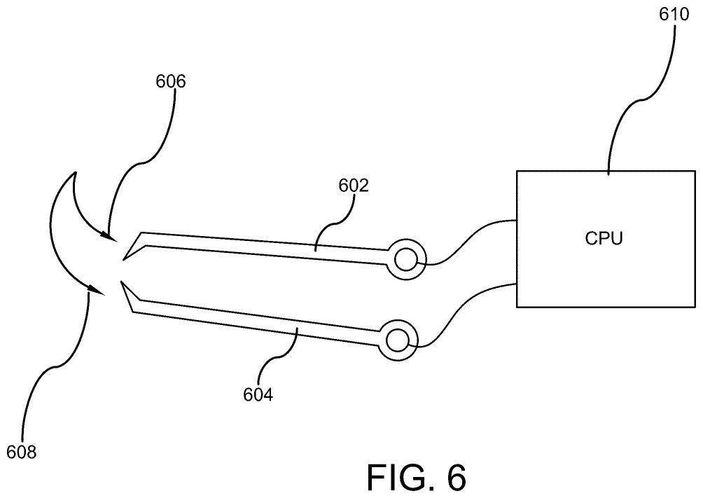

FIG. 5 illustrates a flow chart depicting a process of securing the plug and the socket module in accordance with the disclosed structure. Initially, the plug tongue 316 is inserted into the socket cavity 410 (Step 502). Then, the silicone and neoprene sleeves of the plug and the socket compress, thereby providing a tight seal (Step 504). As the plug slides into the socket, the magnetized pellets of the plug 302 align with the pellets of the socket 402 (Step 506) and electrical metal strips as shown in FIG. 6 make contact to complete a circuit (Step 508).

Then, the robot's system senses the completed circuit and triggers current in the coil windings 314 around the washers to induce magnetism (Step 510). When magnetism is induced, the plug 302 is held firmly attached to the socket 402 via magnetic attraction and the robot receives confirmation from a contact sensor strip.

FIG. 6 illustrates a standalone view of the electrical metal strips used in the robotic simulation system of the present invention in accordance with the disclosed structure. The system 100 includes a pair of thin copper or nickel strips 602, 604. The first strip 602 is coupled to the plug and the second strip 604 is coupled to the socket. When the tip ends 606, 608 of the strips 602, 604 respectively, touch on secure attachment of the plug and the socket, the circuit is complete of the robotic simulation system and a signal is sent to the robot's processing unit 610 for installation of the robotic simulation system 100.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “modular robotic simulation system, “robotic simulation system”, and “system” are interchangeable and refer to the modular robotic simulation system 100 of the present invention.

Notwithstanding the forgoing, the modular robotic simulation system 100 of the present invention can be of any suitable configuration as is known in the art without affecting the overall concept of the invention, provided that it accomplishes the above stated objectives. One of ordinary skill in the art will appreciate that the modular robotic simulation system 100 as shown in the FIGS. are for illustrative purposes only, and that many other configurations of the modular robotic simulation system 100 are well within the scope of the present disclosure. Although the dimensions of the modular robotic simulation system 100 are important design parameters for user convenience, the modular robotic simulation system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A simulation system for a robot comprising:
a molded form shaped as simulated human body parts having a molded medical-grade silicone outer layer, a metallic member inner layer, and a plurality of connectors;
wherein said metallic member inner layer attachable to a robot's framework;
wherein said plurality of connectors of the robot's framework attachable to said metallic member inner layer to provide transmission of execution signals and control in movement of said molded form;
wherein said metallic member inner layer having a rubber tube proximal to said metallic member inner layer to transport temperature-controlled water therethrough;
wherein said temperature-controlled water is controlled at a human skin temperature; and
further wherein said simulated human body parts are selected from the group consisting of an arm, a face, a leg, a penis, and a vagina.

2. The simulation system for a robot of claim 1, wherein said metallic member having a plug and socket mechanism forming an interface between said molded medical-grade silicone outer layer and the robot's framework.

3. The simulation system for a robot of claim 2, wherein said molded medical-grade silicone outer layer in a form of a humanoid robotic face skin module having said molded medical-grade silicone outer layer shaped as a human face.

4. The simulation system for a robot of claim 3, wherein said molded medical-grade silicone outer layer including human anatomical features selected from the group consisting of one or more of a mouth, a nose, and a pair of eyes.

5. The simulation system for a robot of claim 4, wherein said metallic member inner layer having a plurality of actuators for providing and simulating facial expressions of the human face.

6. The simulation system for a robot of claim 1 further comprising at least one metal strip extending alongside and parallel to said rubber tube, and further wherein said at least one metal strip having a sensor for measuring the amount of tactile pressure applied thereto.

7. A simulation system for a robot comprising:
a molded form shaped as simulated human body parts having a molded medical-grade silicone outer layer, a metallic member inner layer, and a plurality of connectors;
wherein said metallic member inner layer attachable to a robot's framework;
wherein said plurality of connectors of the robot's framework attachable to said metallic member inner layer to provide transmission of execution signals and control in movement of said molded form;
wherein said metallic member inner layer having a rubber tube proximal to said metallic member inner layer to transport temperature-controlled water therethrough;
wherein said temperature-controlled water is controlled at a human skin temperature;
wherein said simulated human body parts are selected from the group consisting of an arm, a face, a leg, a penis, and a vagina;
wherein said molded form having a plug module including a plug for attaching to a socket in the robot's framework;
wherein said molded form having a silicone outer sleeve forming said molded medical-grade silicone outer layer; and
further wherein said molded form including a neoprene inner sleeve having a plurality of magnetized pellets for providing multi-point magnetic engagement with the robot's framework.

8. The simulation system for a robot of claim 7, wherein said plug module having a first iron washer and a first wire coil, and further wherein said first iron washer is a first core for an electromagnetic field during activation of said first wire coil.

9. The simulation system for a robot of claim 8, wherein said first wire coil is a first copper wire coil wrapped around said first iron washer.

10. The simulation system for a robot of claim 9, wherein said plug module having a second iron washer and a second wire coil, and further wherein said second iron washer is a second core for an electromagnetic field during activation of said second wire coil.

11. The simulation system for a robot of claim 10, wherein said second wire coil is a second copper wire coil wrapped around said second iron washer.

12. The simulation system for a robot of claim 7, wherein said molded medical-grade silicone outer layer in a form of a humanoid robotic face skin module having said molded medical-grade silicone outer layer shaped as a human face.

13. The simulation system for a robot of claim 12, wherein said molded medical-grade silicone outer layer including human anatomical features selected from the group consisting of one or more of a mouth, a nose, and a pair of eyes.

14. The simulation system for a robot of claim 13, wherein said metallic member inner layer having a plurality of actuators for providing and simulating facial expressions of the human face.

15. The simulation system for a robot of claim 14 further comprising at least one metal strip extending alongside and parallel to said rubber tube, and further wherein said at least one metal strip having a sensor for measuring the amount of tactile pressure applied thereto.

16. A simulation system for a robot comprising:
a molded form shaped as simulated human body parts including a molded medical-grade silicone outer layer, a metallic member inner layer, and a plurality of connectors;
wherein said metallic member inner layer attachable to a robot's framework;
wherein said plurality of connectors of the robot's framework attachable to said metallic member inner layer to provide transmission of execution signals and control in movement of said molded form;
wherein said metallic member inner layer having a rubber tube proximal to said metallic member inner layer to transport temperature-controlled water therethrough;
wherein said temperature-controlled water is controlled at a human skin temperature;
wherein said molded medical-grade silicone outer layer in a form of a humanoid robotic face skin module having said molded medical-grade silicone outer layer shaped as a human face;
wherein said molded medical-grade silicone outer layer including human anatomical features selected from the group consisting of one or more of a mouth, a nose, and a pair of eyes;
wherein said molded form having a plug module including a plug for attaching to a socket in the robot's framework;
wherein said molded form having a silicone outer sleeve forming said molded medical-grade silicone outer layer; and
further wherein said molded form including a neoprene inner sleeve having a plurality of magnetized pellets for providing multi-point magnetic engagement with the robot's framework.

17. The simulation system for a robot of claim 16, wherein said plug module having a first iron washer and a first wire coil, and further wherein said first iron washer is a first core for an electromagnetic field during activation of said first wire coil.

18. The simulation system for a robot of claim 17, wherein said plug module having a second iron washer and a second wire coil, and further wherein said second iron washer is a second core for an electromagnetic field during activation of said second wire coil.

19. The simulation system for a robot of claim 16, wherein said metallic member inner layer having a plurality of actuators for providing and simulating facial expressions of the human face.

20. The simulation system for a robot of claim 16 further comprising at least one metal strip extending alongside and parallel to said rubber tube, and further wherein said at least one metal strip having a sensor for measuring the amount of tactile pressure applied thereto.
